(19) United States
(12) Patent Application Publication
(10) Pub. No.: US 2016/0255822 A1
(43) Pub. Date: Sep. 8, 2016

(54) Multi-armed Fishing Apparatus

(71) Applicant: John W. Whitman, Gatesville, MD (US)

(72) Inventor: John W. Whitman, Gatesville, MD (US)

(21) Appl. No.: 14/012,787

(22) Filed: Aug. 28, 2013

(51) Int. Cl. A01K 85/00

(52) U.S. Cl. CPC A01K 85/00

(57) ABSTRACT

A multi-armed device for catching fish where the device travels through the water suspended from a fishing line. The line is attached to a central line attachment on the device having a plurality of arms, with the arms projecting generally radially from the central attachment. Leaders with lures or teasers may be connected to the ends of the arms or they can be attached to the arms themselves. The teasers rotate when the device travels though water rotating, alternately, first in one direction approximately 180° about the axis of the body and then reversing and rotating in the opposite direction approximately 180° such that the opposite sides of the teaser are displayed alternately. At least one lure may be detachably affixed to the device.

### FIELD OF THE INVENTION

The present invention relates to apparatus used in sport fishing to suspend multiple fishing lures in such a manner that fish are attracted to and strike the lures presented by the apparatus. More specifically the present invention is a multi-armed umbrella rig, including devices to attract the fish as well as lures that include at least one hook for catching fish that attempt to ingest the lure as the device moves through the water.

### BACKGROUND OF THE INVENTION

There are many devices that are used to suspend fishing lures behind a moving boat to catch fish by trolling. Normally the line on a fishing reel is attached to at least one lure and the line rotates the spool of the reel to strip line from the spool when the drag on the reel is disengaged or when the forward motion of the boat creates enough drag on the lure(s) to exceed the drag setting on the reel. Because the drag setting on conventional reels are adjustable, the setting can be such that the drag of the device through the water does not strip line from the reel under ordinary circumstances. The devices may suspend a single lure or bait and may or may not include other devices than the lure (commonly referred to as “teasers”) to attract the fish. Because many fish are attracted to schools of bait fish while feeding, devices have been created to suspend more than one lure on one device. One such device is commonly known as an “umbrella rig” because such devices include several arms projecting from a central member that resemble the bows of an umbrella. An umbrella rig may include four or more lateral arms projecting from a central hub-like element where the line leading to the reel is attached.

It is known in the art to include both lures with hooks and teasers on a single umbrella rig. The teasers attract the fish seeking to feed on a school of fish and, if the lure induces the fish to strike it or ingest it, the lure hooks the fish. If the fish is sufficiently large or attempts to swim away while hooked, the increase in the drag on line leading to the reel deflects the rod and/or strips line from the reel such that the presence of the hooked fish on the lure is detected.

The reaction of fish to a lure or teasers and a lure determines if the fish strikes the lure. As a result, fishermen experiment with rigs, teasers, lures and their combinations in an attempt to find combinations that are more successful than others. Those combinations may work better on different fish species, in different water conditions, under different weather conditions, at different trolling speeds, and enough other variables that fishermen experiment with many different rigs and combinations of rigs, teasers and lures to maximize the probability that a desired fish species will be attracted and strike or ingest the lure.

The purpose of the present invention is to provide a combination of components for an umbrella rig that successfully attracts fish and induces them to strike or ingest the lures on the rig.

### SUMMARY OF THE INVENTION

The present invention is a device for catching fish using a line issuing from a reel. The device is induced to travel through the water suspended from the line. The motion of the water past the device induces movement of the lures on the device and attracts fish. Such motion can be induced by trolling the device behind a boat. In accordance with the invention the device includes a central line attachment disposed to be detachably affixed to the line. A plurality of arms are affixed to the line attachment, with the arms projecting generally radially from the central attachment. Each arm has a proximal end affixed to the central line attachment and a distal end spaced a distance from the central line attachment. In accordance with the invention, the device further includes leaders connected to the distal ends of the arms. The proximal ends of the leaders are attached to the distal ends of the arms and the distal ends of the leaders have connectors affixed thereon.

A plurality of teasers are detachably affixed to the connectors on the distal ends of a plurality of the leaders. The teasers are comprised of an elongated body with a first side being concave and an opposite second side being convex. The transverse width of the body is greater at its central portion than at either end. Both sides of the body are reflective of light, with the reflectivity of the first and second sides being sufficiently different that the difference in reflectivity is perceptible. The difference in reflectivity is the result of differences in texture of the first and second sides or the result of differences in the color of the first and second sides. The shape of the body is such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body.

A plurality of lures are detachably affixed to the connectors on the distal ends of a plurality of the leaders. The lures are comprised of an elongated body with a first side being concave and an opposite second side being convex. The transverse width of the body is greater at its central portion than at either end. Both sides of the body are reflective of light, the reflectivity of the first and second sides being sufficiently different that the difference in reflectivity is perceptible. The difference in reflectivity is the result of differences in texture of the first and second sides or the result of differences in the color of the first and second sides. The shape of the body is such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body.

In a preferred embodiment the length of the leaders are not all equal such that the lures and teasers are displaced different distances along the direction of travel of the device through the water.

In another preferred embodiment the first side of the teaser is a color different than the color of the second side of the teaser.

One of the purposes of the invention is to provide a device that effectively attracts fish by simulating the appearance of a school of swimming bait fish and induces fish seeing the device to strike the lures. Another purpose of the invention is to provide a simple device, that is easy to manufacture, and can be manufactured at a reasonable cost.

These and other objects of the invention may be achieved by the embodiments described herein.

### BRIEF DESCRIPTION OF THE DRAWINGS

FIG. 1 is a perspective view of an umbrella rig embodying the present invention.

FIG. 2 is a side elevation view of an umbrella rig embodying the present invention.

FIGS. 3A, 3B and 3C respectively are the front, side, and top views of an embodiment of a teaser.

FIG. 4A, 4B and 4C respectively are the front, side, and top views of an embodiment of a lure.

### DESCRIPTION OF THE PREFERRED EMBODIMENTS

In accordance with the invention there is provided a device for catching fish using a line issuing from a reel. As the invention is operable with any type of line or reel, the disclosure or depiction of a particular type of line or reel is unnecessary. A convention trolling reel having an adjustable drag setting and the means to disengage the drag on the spool is operable with the invention. The invention is particularly suited to trolling where the device is induced to travel through the water suspended from the line. The motion of the water past the device induces movement of the lures on the device and attracts fish. Such motion can be induced by trolling the device behind a boat.

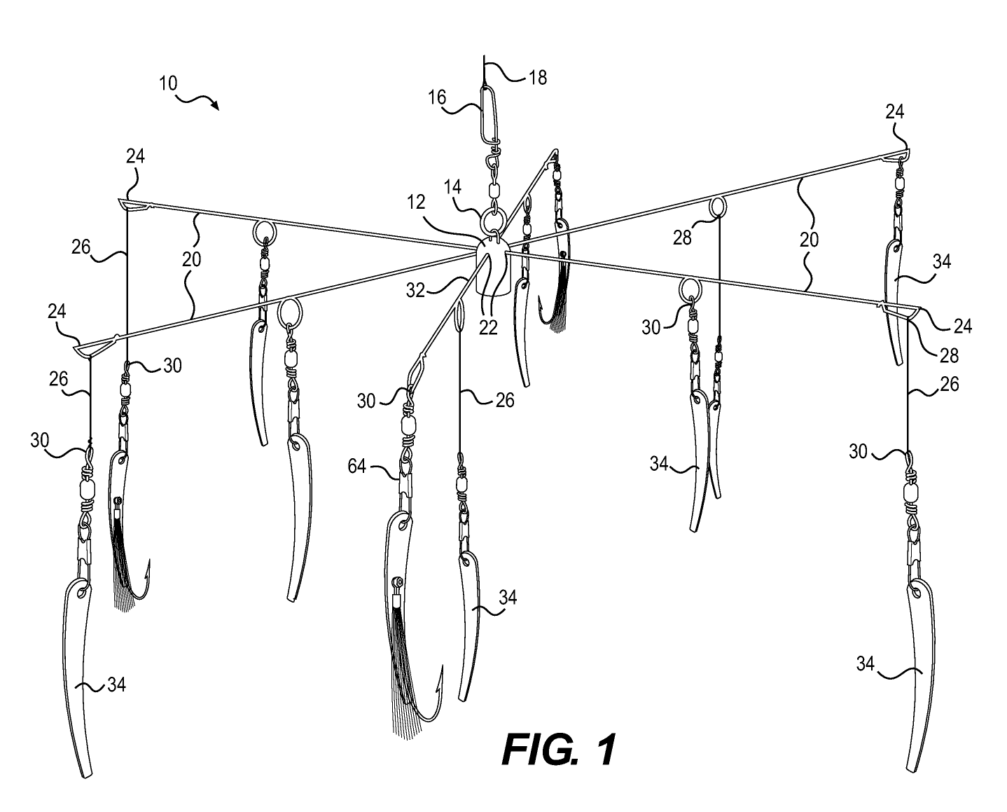

In accordance with the invention the device includes a central line attachment disposed to be detachably affixed to the line. As here embodied and depicted in FIG. 1 the device 10 includes a central line attachment 12 having a central connector 14 connect to a leader 16, which is in turn connected by conventional fishing line 18 to a reel (not shown). The connections may be simply detachable connections or may have associated swivels. The central line attachment 12 may be a solid element or may include apparatus to allow the arms to pivot to low drag positions when a fish induces sufficient drag on the device. See US2003/0208948A1, published Nov. 11, 2003 and a related application, US2005/0050790A1, published Mar. 10, 2005.

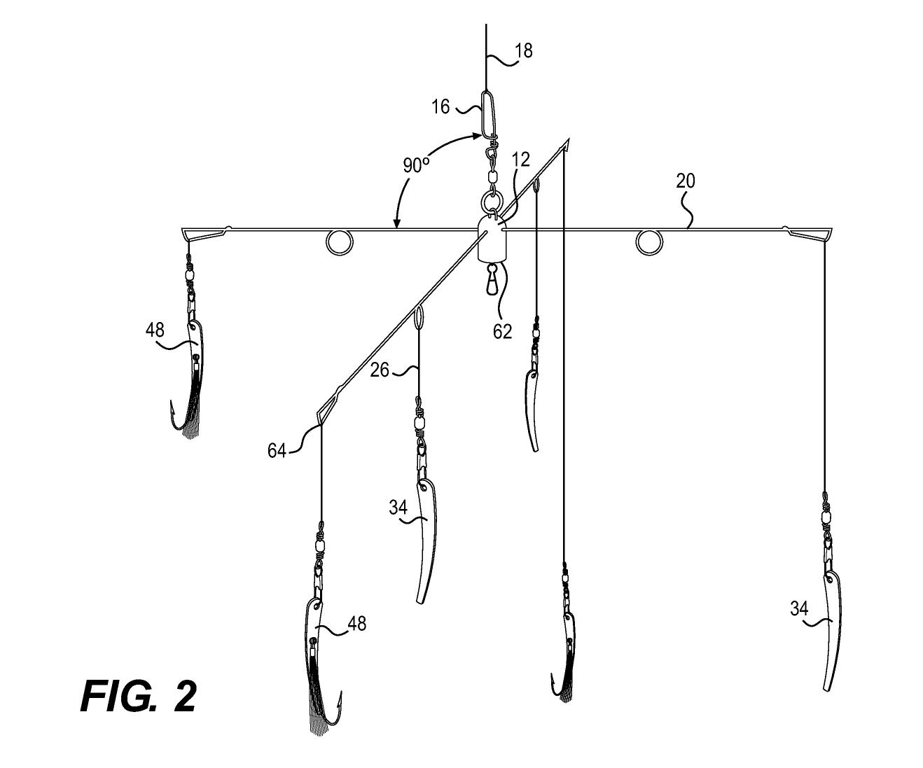

In accordance with the invention a plurality of arms are affixed to the line attachment. As here embodied the device may include a plurality of arms 20 projecting generally radially from the central attachment 12. While the device 10 is depicted herein with four arms 20, in another embodiment (not shown) there are included six radially extending arms. As shown in FIG. 2, in the embodiment depicted the arms 20 are at 90° from the direction the device is trolled (the axis of the line leading to the reel) but that is not necessary. The angle shown as 90° in FIG. 2 could be greater than 90° and still be considered generally radial, as that term is used herein. In a preferred embodiment the arms 20 are constructed out of metal wire of an appropriate size and strength to withstand the bending forces applied to them during trolling without plastically deforming. In addition, when a fish is hooked the arm must have the strength to transmit the drag induced by the rig and the fish to the line 18 without permanently deforming or fracturing. Conventional umbrella rigs have such characteristics, and the present invention does not induce stresses materially different than those applied to conventional umbrella rigs. As here embodied the arms 20 are made of conventional steel wire having an approximate diameter of 0.078 inches.

In accordance with the invention each arm has a proximal end affixed to the central line attachment and a distal end spaced a distance from the central line attachment. As here embodied each arm 20 includes a proximal end 22 and a distal end 24. The proximal ends 22 are affixed to the central line attachment 12. In the embodiment depicted the lengths of the arms 20 are equal but that is not necessary. As long as the rig can be trolled without tangling the lines with the teasers and lures the lengths of the arms relative to one another is not significant. The length of the arms and the location of the teasers either on the arms or on lines or leaders on the ends of the arms 20 determine the “density” and spatial distribution of the teasers and lures as seen by a fish. Because the rig is attempting to create a display that suggests a school of swimming fish, the longer the arms the more diffuse are the fake fish in the school of fake fish created by the rig. One skilled in the art can determine the length of the arms based on performance of the invention or use the arm length of conventional umbrella rigs as the special arrangement of the display of fake fish created by the present invention and its embodiments is not known to be unique.

In accordance with the invention, the device further includes leaders connected to the distal ends of the arms. The proximal ends of the leaders are attached to the distal ends of the arms and the distal ends forth leaders have connectors affixed thereon. As here embodied the leaders 26 have proximal ends 28 and distal ends 30 and the length of the leaders 26 is preferably not equal so as to create the appearance of a dispersed school of fish. As shown in FIG. 1 a leader is not necessary for all the teasers and lures, and at least one of the lures or teasers can be directly connected to the arm 20 as long as others are displaced along the axis of movement of the device. As is also apparent from the embodiment of FIG. 1, the leaders may be attached at locations other than the ends of the arms 20, again to simulate a dispersed school of fish traveling through the water at different distances from the axis of movement of the device and different distances along that same axis. The device 10 may also include an arm 32 trailing behind the central line attachment 12.

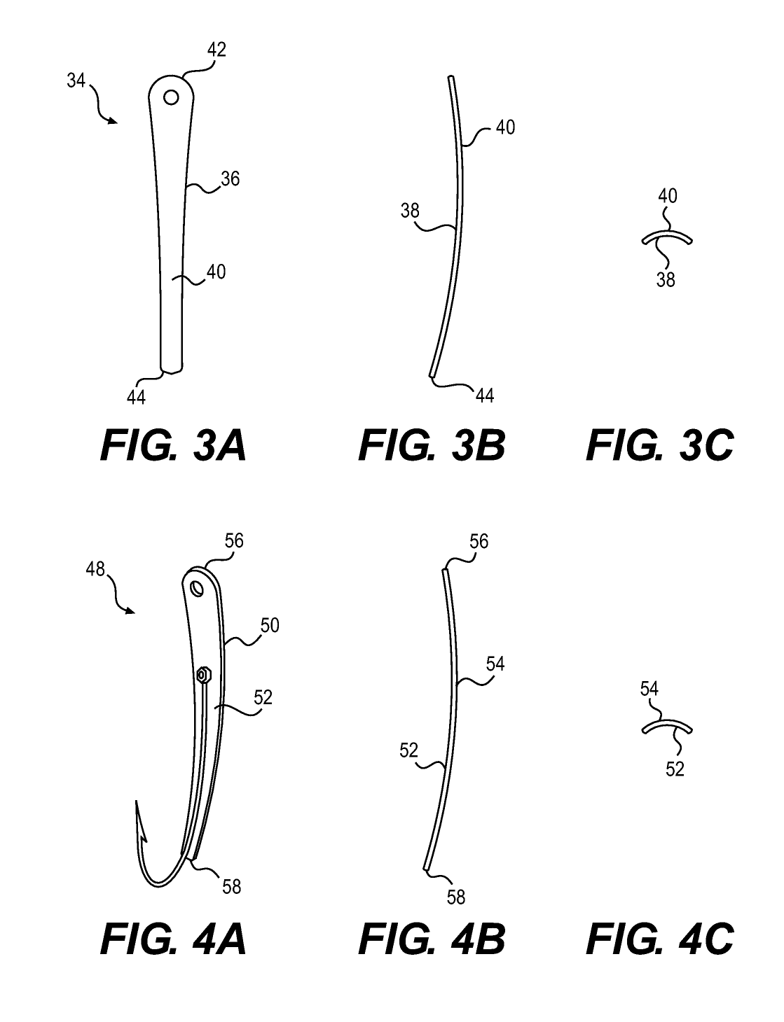

In accordance with the invention, a plurality of teasers are detachably affixed to the connectors on the distal ends of a plurality of the leaders. As here embodied, and most clearly depicted in FIG. 3A, B and C, the teasers 34 are comprised of an elongated body 36 with a first side 38 being concave and an opposite second side 40 being convex. The transverse width of the body is greater at the end 42 affixed to the connector 30 (the proximal end) than the width at the opposite distal end 46 and the proximal end 42 is preferably semi-circular. In a preferred embodiment the teaser body is made from stamped sheet metal of generally uniform thickness so the curvatures of the first and second sides (here 38 and 40) have substantially the same radius of curvature.

In accordance with the invention, both sides of the body are reflective of light, with the reflectivity of the first and second sides being sufficiently different that the difference in reflectivity is visually perceptible. As here embodied the teaser body 34 has a first side 38 of polished metal, preferably a grade of stainless steel that is sufficiently corrosion resistant such that the reflectivity of the polished surface is not degraded by exposure to salt water. As here embodied, the second side 40 of the teaser body 34 has a colored surface, preferably high visibility green. The color may be provided by a coating such as paint or an adhesive tape applied to the second side 40. The coating or tape preferably is resistant to fading, and sufficiently adherent in a marine environment, such that the color contrast between the first side 38 and the second side 40 remain visually significant during the useful life of the device. As here embodied, the teasers 34 have a tape applied to the concave outer surface 40. The tape is highly optically reflective. Alternatively, the tape can have a reflective silver surface resembling an “engine-turned” metal surface, i.e. a regular pattern of circular elements resembling brushed metal. In such embodiments the difference in reflectivity is the result of differences in texture of the first and second sides of the teasers are the result of differences in the color of the first and second sides.

The difference in reflectivity can also be created by altering the normally reflective surface of the lure or teaser using texture. The surface may be stamped to induce a light diffusing texture, or otherwise treated or mechanically abraded to provide a contrast in reflectivity between the opposite sides.

In accordance with the invention, the shape of the body of the teaser is such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body. As here embodied, the teasers have a length of approximately four inches, a width at the proximal end 44 of one-half inch, a width at the distal end 46 of one-fourth inch, a radius of curvature along the length of the teaser of twelve inches, and a transverse radius of curvature of five inches.

In accordance with the invention, a plurality of lures are detachably affixed to the connectors on the distal ends of a plurality of the leaders. As here embodied, and most clearly depicted in FIG. 4A, B and C, the lures 48 are comprised of an elongated body 50 with a first side 52 being concave and an opposite second side 54 being convex. The transverse width of the body is greater at the end 56 affixed to the connector (the proximal end) than the width at the opposite distal end 58 and the proximal end 56 is preferably semi-circular. In a preferred embodiment the teaser body is made from stamped sheet metal of generally uniform thickness so the curvatures of the first and second sides (here 52 and 54) have substantially the same radius of curvature. As here embodied, the lures have a length of approximately four inches, a width at the proximal end 56 of about one-half inch, a width at the distal end 58 of about one-fourth inch, a radius of curvature along the length of the lure of about twelve inches, and a transverse radius of curvature of about five inches.

In accordance with the invention, both sides of the body are reflective of light, with the reflectivity of the first and second sides being sufficiently different that the difference in reflectivity is visually perceptible. As here embodied the lure 48 has a first side 52 of polished metal, preferably a grade of stainless steel that is sufficiently corrosion resistant such that the reflectivity of the polished surface is not degraded by exposure to salt water. As here embodied, the second side 54 of the lure 48 has a colored surface, preferably high visibility green. The color may be provided by a coating such as paint or an adhesive tape applied to the second side 54. The coating or tape preferably is resistant to fading, and sufficiently adherent in a marine environment, such that the color contrast between the first side 52 and the second side 54 remain visually significant during the useful life of the device. As here embodied, the lures 48 have a tape applied to the concave outer surface 52. The tape has a reflective silver surface resembling an “engine-turned” metal surface, i.e. a regular pattern of circular elements resembling brushed metal. In such embodiments the difference in reflectivity is the result of differences in texture of the first and second sides of the teasers are the result of differences in the color of the first and second sides.

In accordance with the invention, the shape of the body such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body.

In a preferred embodiment the length of the leaders are not all equal such that the lures and teasers are displaced different distances along the direction of travel of the device through the water. As here embodied, and most clearly depicted in FIG. 2, the lures 34 are disposed on leaders 26 of different lengths.

In a preferred embodiment the arms are metal wire. As here embodied, and as depicted in FIGS. 1 and 3 the arms 20 are steel wire of an approximate diameter of 0.078 inches, having conventional bent ends that provide a detachable connection to either leaders, lures, or teasers. Preferably, the device includes at least four radial arms and most preferably six.

In another preferred embodiment the device includes a central arm extending from the central line attachment in a direction generally parallel to the direction of travel of the device through the water, with its proximal end mounted to the central line attachment and an opposite distal end. As here embodied and shown in FIG. 2 the device includes a central arm 32 extending from the central line attachment 12 in a direction generally parallel to the direction of travel of the device through the water. The proximal end 62 of the central arm 32 is mounted to the central line attachment 12 and has an opposite distal end 64. Preferably, the central arm 32 has affixed thereto a teaser 66 at its approximate midpoint and a lure 48 at its distal end 64.

What is claimed is:

1. A device for catching fish using a line issuing from a reel, where the device is induced to travel through the water suspended from the line, the device comprising:
a central line attachment disposed to be detachably affixed to the line;
a plurality of arms affixed to the line attachment, the arms projecting generally radially from the central attachment, each arm having a proximal end affixed to the central line attachment and a distal end spaced a distance from the central line attachment;
leaders connected to the distal ends of the arms, the proximal ends of the leaders being attached to the distal ends of the arms and the distal ends of the leaders having connectors affixed thereon; and
a plurality of teasers detachably affixed to the connectors on the distal ends of a plurality of the leaders, the teasers being comprised of an elongated body with a first side being concave and an opposite second side being convex, the transverse width of the body being greater at its central portion than at either end, both sides of the body being reflective of light, the reflectivity of the first and second sides being sufficiently different that the difference in reflectivity is perceptible, the difference in reflectivity being the result of differences in texture of the first and second sides or the result of differences in the color of the first and second sides, the shape of the body being such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body.

2. The device of claim 1 further including:
a plurality of lures detachably affixed to the connectors on the distal ends of a plurality of the leaders, the lures being comprised of an elongated body with a first side being concave and an opposite second side being convex, the transverse width of the body being greater at its central portion than at either end, both sides of the body being reflective of light, the reflectivity of the first and second sides being sufficiently different that the difference in reflectivity is perceptible, the difference in reflectivity being the result of differences in texture of the first and second sides or the result of differences in the color of the first and second sides, the shape of the body being such that the body rotates about its axis of rotation when the device travels though water alternately, rotating first in one direction approximately 180° about the axis of the body and then reversing the direction of rotation and rotating in the opposite direction approximately 180° such that the opposite sides of the lure are displayed alternately at a distance radially from the axis of rotation of the body.

3. The device of claim 2 wherein the length of the leaders are not all equal such that the lures are displaced different distances along the direction of travel of the device through the water.

4. The device of claim 1 wherein the length of the leaders are not all equal such that the teasers are displaced different distances along the direction of travel of the device through the water.

5. The device of claim 1 wherein the arms are metal wire.

6. The device of claim 1 wherein the device includes at least four arms.

7. The device of claim 1 wherein the first side of the teaser is a color different than the color of the second side of the teaser.

8. The device of claim 2 wherein the first side of the lure is a texture different than the texture of the second side of the lure.

9. The device of claim 2 wherein the device includes a central arm extending from the central line attachment in a direction generally parallel to the direction of travel of the device through the water, with its proximal end mounted to the central line attachment and an opposite distal end.

10. The device of claim 9 wherein the central arm has affixed thereto a teaser at its approximate midpoint and a lure at its distal end.
